(19) United States
(12) Patent Application Publication
(10) Pub. No.: US 2003/0198339 A1
(43) Pub. Date: Oct. 23, 2003

(54) Enhanced sound processing system for use with sound radiators

(76) Inventors: Kenneth P. Roy, Holtwood, PA (US); Thomas J. Johnson, Chesterfield, MO (US); Ronald Fuller, Burbank, CA (US); Steve Dove, Lebanon, PA (US)

Correspondence Address: James F. Vaughan, Womble Carlyle Sandridge & Rice, PLLC, P.O. Box 7037, Atlanta, GA, 30357-0037, US

(21) Appl. No.: 10/126,592

(22) Filed: Apr. 19, 2002

(51) Int. Cl. H04M 1/00; H04M 9/00

(52) U.S. Cl. 379/387.01

(57) ABSTRACT

A compact sound processing system and method for use with a plurality of sound radiators. A microcontroller accepts a plurality of user-selected speaker equalization and space equalization settings and receives a paging control signal from a telephone interface. An analog mixer combines music signal inputs and a paging signal. A digital signal processor generates and filters masking noise, and processes the masking noise and combined music and paging signals based on user-selectable settings for distribution to the sound radiators. An audio amplifier modulates and amplifies the output signal from the digital signal processor, and delivers the output signal to the sound radiators via a transformer in defined zones. The sound radiators can be flat panel sound radiators or conventional type speakers. A masking filter used with the masking noise generator can be programmed to shape the virtual random noise generated by decreasing the noise at a constant rate over the frequency range of human speech. A paging over music function reduces the music sound level by a preset amount whenever a paging control signal is received. A talkback controller is also provided to enable an individual to respond to a page using the sound radiator as a microphone.

### CROSS-REFERENCE TO RELATED APPLICATIONS

This application is related to co-pending and commonly assigned patent applications “Flat Panel Sound Radiator and Assembly System,” Ser. No. 09/627,706, filed Jul. 28, 2000; “Flat Panel Sound Radiator with Special Edge Details,” Ser. No. 09/641,071, filed Aug. 17, 2000; “Flat Panel Sound Radiator with Enhanced Audio Performance,” Ser. No. 10/003,928, filed Oct. 31, 2001; Flat Panel Sound Radiator with Supported Exciter and Compliant Surround,” Ser. No. 10/003,929, filed Oct. 31, 2001; and “Architectural Sound Enhancement with Pre-Filtered Masking Sound,” Ser. No. (Attorney Docket A148 1700.1), filed Mar. 28, 2002. Each co-pending patent application is hereby incorporated by reference into this description as fully as if here represented in full.

### BACKGROUND OF THE INVENTION

The present invention relates generally to sound processing systems. More particularly, the present invention relates to digital sound processing systems that provide a combination of masking sound, paging, and music in small to medium professional offices and school environments.

The traditional method of distributing sound throughout an office environment has been to mount an array of cone type loudspeakers in the suspended ceilings of the office environment and to connect the speakers to an audio amplifier driven by masking noise sources, music, paging, or other sound sources. The traditional cone and horn type loudspeakers known in the prior art are referred to herein as conventional speaker technology. There are numerous problems inherent in this traditional method of sound distribution: (1) low fidelity of the resulting sound; (2) the difficulty of reconfiguring the speaker array when the floor plan changes; (3) the distracting directional and non-diffuse character of the sound produced by traditional cone-type loudspeakers; (4) the relative loudness and quiet of different areas as one moves about the office environment; (5) the interference patterns resulting from the spaced-apart speakers producing correlated sound; and (6) the changing characteristics of the audio program with varying room acoustics within the office environment. Some of the problems mentioned above have been addressed by the assignee of the present invention through its development of flat panel sound radiators that are mounted within the grid of a suspended ceiling and are visually indistinguishable from traditional ceiling panels.

Studies have indicated that noise is the single largest distraction within the workplace. Contributing to the amount of noise within a workplace, are the conversations of other employees, the more frequent use of speaker phones, personal sound systems, computers with large sound reflective screens, and voice recognition systems for communicating verbally with a computer. In larger office environments, open plan work spaces are used, resulting in large rooms with reduced ceiling height and moveable, reconfigurable partitions that define the cubicles in which employees work. Distracting sound propagates over and through the partition walls to reach workers operating in adjacent cubicles. Several of these sources of noise are also present in smaller to medium-sized office environments and classroom settings.

Sound masking techniques are being used increasingly to mask and neutralize distracting sounds. The principles of sound masking involve the introduction into an environment of sound that is tailored to mask the targeted distracting noises. Distracting human conversations can be masked by the introduction of masking sounds into the environment with a predetermined frequency profile within the frequency spectrum of the human voice. Typical sound masking systems include a pink noise or white noise generator, an audio amplifier and frequency filter, and an array of connected loudspeakers throughout the environment to reproduce the masking sounds and to create a uniform sound field within the environment. Continuous frequency spectrum noise that has equal energy in each cycle is termed “white noise”.

Continuous frequency spectrum noise that has equal energy in each constant percentage bandwidth (i.e., octave band) is termed “pink noise”. If white noise has equal energy in every cycle, there must be twice as much energy in each higher frequency octave band than in the adjacent lower frequency band. White noise, therefore, sounds like it contains a lot of treble sound. Pink noise is produced to have equal energy in each constant percentage bandwidth. Pink noise results in sounds that are balanced between bass, mid-frequency and treble sounds. Pink noise is used for making noise reduction measurements, for analyzing loudspeaker response, for generating masking noise to be inserted in an open office environment, etc. White noise is not often used in building acoustics.

The uniformity of the masking sound field is a key factor in rendering the masking sounds undetectable by occupants. The quality and sound characteristics of the resulting sound field when cone-type loudspeakers are positioned in the plenum space above a suspended ceiling, vary with the configuration and contents of the plenum space and with the type of ceiling tile used. It is difficult to compensate for the varying acoustic response in the office environment below the suspended ceiling.

The use of flat panel sound radiators in sound masking systems can enhance the ability to produce a diffuse and uniform masking sound field within the office environment. Since flat panel sound radiators project sound directly into a space, rather than into the plenum above a suspended ceiling, it is easier to tailor the sound produced by the flat panel radiators to compensate for the varying acoustic properties of the space into which they radiate.

Flat panel radiators work on the principle that an exciter connected to the flat panels cause the panels to vibrate, generating sound. The vibration of the panel generates a complex random ripple of wave forms on the panel surface, which in an ideal model radiates sound in an omni directional pattern from the panel.

The noise level in a space can be effectively described with a single number rating called the noise criteria (NC) rating. The NC rating is determined by measuring the sound pressure level of the ambient noise in each octave band, plotting these levels on a graph, and then comparing the results to established NC curves. The lowest NC curve not exceeded by the plotted noise spectrum is the NC rating of the sound. The appropriate background noise level for a typical classroom is about NC-30. For comparison, a typical office environment might have a background level of about NC-35 to NC-40, which is a level produced by standard HVAC system design. A ten decibel (dB) decrease or increase in background noise will be judged by the ear to be about half, or twice as loud, respectively.

Attempts have been made to filter pink noise in a workspace environment in order to produce a masking sound having a NC-40 distribution within the space. While NC-40 filtered masking sound is somewhat more efficient at masking distracting sounds, it can have an annoying effect upon persons working in the space, particularly after prolonged exposure. This may be the result of a power level distribution that is increased at the low and high frequencies, and is decreased at mid-level frequencies.

There exists a need for a commercial sound distribution system for small-to-medium office spaces, as well as classroom environments that integrates masking sound, music, and paging using sound radiator technology to produce a diffuse and consistent sound field within the space, especially when reproducing masking sounds, and while producing high quality background music and paging. The masking sounds should be tailored to the environment to provide optimum masking of human speech and other distracting sounds within the space to ensure both speech intelligibility within the environment, but also to maintain speech privacy in those settings where that becomes an issue.

### SUMMARY OF THE INVENTION

The present invention is directed to a digital signal processing system for sound radiators that provides masking sound, background music and paging capabilty in small-to-medium professional office settings and school environments. Typical small-to-medium professional office settings can include doctor offices where privacy is an issue, law offices, and realtor offices to name just a few. By integrating making sound, music and paging into a single digital processing system, a cost savings results from the elimination of redundant electronics and other hardware.

The digital signal processor for the sound radiators can be mounted on a wall, placed on a shelf within a cabinet or rack, or integrated with the sound radiator mounted in the T-bar grid of a suspended ceiling. The digital signal processor provides multiple pre-filtered curves for sound masking with manual selection, and line level inputs for existing and/or new paging and music systems with minimal manual adjustment and tuning required. The invention further provides pulse width modulated (PWM) Class D stereo amplification to power the sound radiators.

Flat panel radiators are ideally suited for sound masking since they have broad acoustic radiation patterns at the frequencies required for sound masking. The flat panel radiator includes a radiating panel, a transducer attached to the radiating panel, and wiring connected to an excitation source. When electrical current is passed through the voice coil, the resulting combination of the electromagnetic field forces with the magnetic field induces a small relative displacement, or bending, of the panel material at the mounting points. The motion of the flat panel is incoherent containing many complex modes spread over the entire surface of the radiator. The flat panel radiator is usually mounted in a suspended ceiling grid, although other configurations and locations are possible.

### DESCRIPTION OF THE DRAWINGS

The invention is better understood by reading the following detailed description of exemplary embodiments in conjunction with accompanying drawings.

FIG. 1 illustrates a circuit block diagram of a two-channel sound processing system in accordance with an exemplary embodiment of the present invention.

FIG. 2 illustrates a functional block diagram of a two-channel sound processing system in accordance with an exemplary embodiment of the present invention.

FIGS. 3A-3C illustrate DIP switch truth tables for a two channel sound processing system in accordance with an exemplary embodiment of the present invention.

FIG. 4 illustrates a circuit block diagram of a single channel sound processing system in accordance with an exemplary embodiment of the present invention.

FIG. 5 illustrates a functional block diagram of a single channel sound processing system in accordance with an exemplary embodiment of the present invention.

FIG. 6 illustrates a DIP switch truth table for a single channel sound processing system in accordance with an exemplary embodiment of the present invention.

FIG. 7 illustrates the layout for the electronics box mounted to the top of a flat panel sound radiator cover plate in accordance with an exemplary embodiment of the present invention.

### DETAILED DESCRIPTION OF THE INVENTION

The related patent applications cross-referenced above disclose the use of flat panel radiator technology for generating acoustic signals for masking of noise in an industrial environment. Patent application Ser. Nos. 09/627,706 and 09/641,071 disclose various assemblies for mounting flat panel radiators including installation in a standard inverted “T” ceiling grid. The radiator panel includes an attached bridge support element and an enclosure containing electrical components for connecting a transducer to an external-driving source. Patent application Ser. Nos. 10/003,928 and 10/003,929 disclose the use of flat panel radiators having honeycomb cores sandwiched between facing skins and having defined technical characteristics. Patent application Ser. No. (Attorney Docket No. A148 1700.1) discusses methods for producing masking sound within a space for masking distracting noise and providing enhanced speech privacy. The complete disclosure of each of these five pending applications is hereby incorporated by reference.

Two embodiments of compact sound processing systems for use with sound radiators are described herein. Each embodiment described can operate with flat panel sound radiators or with more traditional types of speaker systems, the flat panel radiator is preferred for the applications discussed herein. The first embodiment described is a two channel masking source with amplification. This embodiment includes line or music inputs as well as a telephone company (TELCO) interface with steerable paging capabilities. This embodiment can serve small to medium-sized business applications of approximately 5,000 to 30,000 square feet with between 10 and 50 flat panel sound radiators. The second embodiment described is a single channel masking source with amplification. This second embodiment includes a line or music input and can be adapted to work with a paging system sourced from another manufacturer. This embodiment can serve small-size business applications of approximately 1,000 to 5,000 square feet with one to 20 flat panel sound radiators. The second embodiment can be installed in the flat panel radiator bridge in place of the electrical connection cover as will be discussed below.

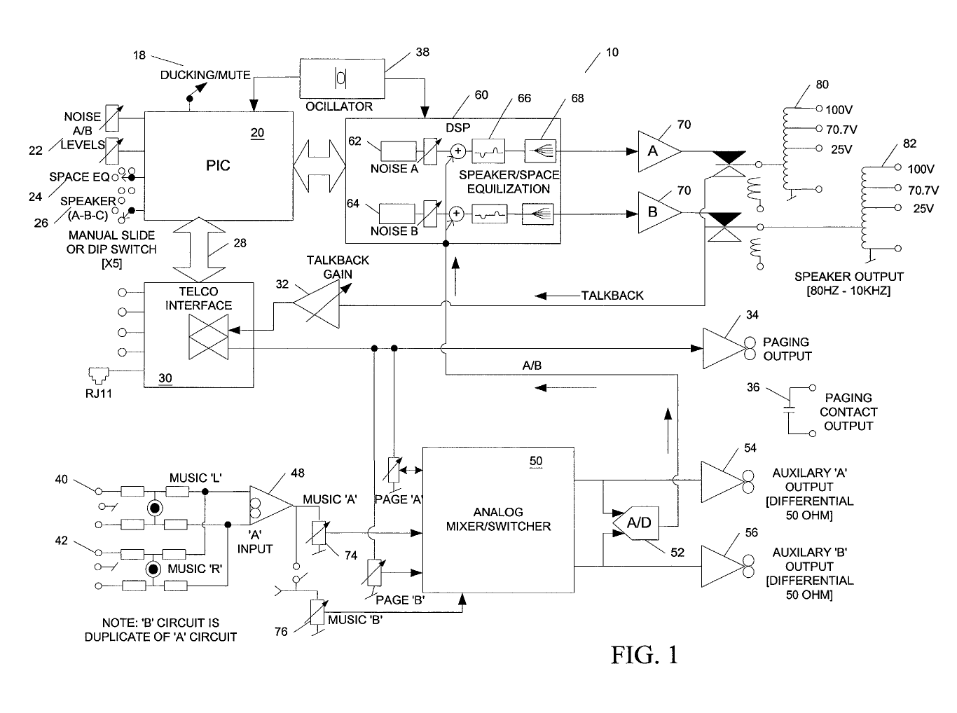

FIG. 1 illustrates a circuit block diagram of a two-channel sound processing system 10 of the present invention. The sound processing system 10 shown in FIG. 1 is a rack-sized device and can be mounted in a rack of equipment in a wiring closet of a building. The sound processing system 10 can be installed in equipment cabinets or equipment racks of varying types. The sound processing system 10 can also be mounted on a wall or can be located on a desktop. The sound processing system 10 shown is not intended for installation in the plenum of an office space. A programmable interface controller 20 (referred to as PIC or microcontroller herein) is an integrated circuit chip that controls the operation of the digital signal processor (DSP) 60 and the telephone interface (TELCO) 30. The noise A/B level inputs 22 to the PIC provides a volume gain control that determines the loudness of the noise that is output from the DSP 60. The PIC 30 accepts the user input on the volume controls 22 and reads the dual in-line package (DIP) switch settings 24, 26 and communicates the settings to the DSP 60. DIP switches are toggle switches having two possible positions—on or off. The switches on the DIP switchboard are used to shift from one DSP program to another. The oscillator 38 provides a clock to keep the DSP 60 running at its fixed sample frequency.

Two uncorrelated noise sources 62, 64 are located in the DSP. The absence of correlation between the two masking noise sources can be accomplished in various ways including by independent pseudorandom or virtual random noise generators. The use of such random noise generators is known in the art of digital signal processor design. Noise A 62 and Noise B 64 can also be digital audio files stored in the processor 60, each containing masking noise that can be kept uncorrelated by starting each digital audio file at a separate time to keep the two digital audio files uncorrelated by virtue of the time shift. After playing through, each masking noise digital audio file repeats, thereby providing a constant pink noise source for use in masking.

The DSP 60 performs speaker (i.e., sound radiator) and space equalization 66, 68 for the DIP switch inputs 24, 26. The speaker (A-B-C) input 26 represents three different types of sound radiators for use with the system. Speakers A and B represent two different types of flat panel sound radiators available from the assignee of the present invention. The flat panel sound radiators have different characteristics with the higher fidelity flat panel sound radiator having an enhanced frequency response. However, both sound radiator types A and B provide an omnidirectional radiation pattern delivering more uniform sound over a broader area of coverage. Speaker type C represents other types of speakers or sound radiators that are compatible with the DSP 60 of the present invention. The space equalization DIP switches 24 provide five different levels of space equalization. One position provides bypass of space equalization entirely and would be used when the response characteristics of the space are not known.

A ducking/muting DIP switch 18 is also provided to enable either muting or ducking of music whenever a page is generated. Ducking provides a paging-over-music function for the sound processing system. In order for an individual to hear a page clearly over music, the level of the page must be at least 10 dB and preferably 20 dB higher than the level of the music.

Paging is handled through the TELCO interface 30. It accepts input from a private branch exchange (PBX) system and enables paging to different zones. Paging inputs can also be received from a key telephone system (KTS), Centrex via the public switched telephone system (PTSN), or voice over Internet Protocol (VoIP). There are separate line or music inputs for both zone A and zone B. The circuit for zone A is depicted in FIG. 1. The circuit for zone B is identical to that for zone A. The line inputs 40, 42, are intended to receive background music signals for routing to zone A or zone B. The inputs 40, 42, are adapted to accept music from typical consumer audio electronic devices. Two different background music programs may be connected and ultimately routed to zone A and zone B within the office environment. The line inputs are input to amplifier 48, which sums the inputs to produce a monophonic signal. The inputs could be from a compact disc player, for example. There is a volume control 74, 76 on the music signals. The page and music inputs from circuits A and B are combined in the analog mixer/switcher 50. The combined signal then passes through an analog to digital converter (A/D) 52 and is input to the DSP 60.

The digitized noise, music and paging signals are summed in the DSP 60 and are processed for speaker equalization 66 and space equalization 68. The speaker and space equalization compensate for known speaker anomalies and known acoustic anomalies of certain spaces. The outputs from the DSP 60 are provided as inputs to a stereo Class D amplifier 70 for zone A and zone B, respectively. A Class D audio amplifier is a switching amplifier that converts a low level, analog input signal into a high power, pulse width modulated (PWM) output. Class D pulse width modulated amplifiers sample input audio signals at a rate of at least 12 times the audio bandwidth, and then recreate the audio signal at the speaker. Pulse width modulation resembles digital data in that it has an on state and an off state. When the output transistors are on, there is low resistance and power is delivered more efficiently to the speaker. When the output transistors are off, no power is consumed or delivered to the speaker and thus there is no loss in the amplifier.

From the stereo Class D amplifier 70 the output goes through a transformer 80, 82 that enables operation on 100 volt, 70.7 volt and 25 volt lines. Typical commercial buildings in the U.S. operate on 70.7 volt distributed lines. The standard for commercial buildings in Europe is 100 volts and schools in the U.S. typically operate at 25 volts. The different distributive power is provided by connecting to different terminals on the output side of the transformer.

Paging and music outputs from the analog mixer/switcher 50 can also be provided to two amplifiers 54, 56 to provide two line outputs (for the A and B circuits) that are capable of driving additional electronic devices. Note that the line outputs do not include any masking or speaker/space equalization. That would be provided by the additional electronic devices. A page output from the TELCO interface 32 is also routed directly to the paging output amplifier 34. This output could be used, for example, if the sound processing system 10 is to be the front end for an additional sound processing system 10 to which the page is to be directed.

A paging contact output 36 is also shown in FIG. 1. This alerts downstream devices that a page is being broadcast. The talkback control 32 enables the flat panel radiator to be used as a microphone. The talkback function enables the paging originator to listen to the area that is to receive a page. A recipient of a page can then communicate with the paging originator through the flat panel radiator acting as a microphone. The paging originator controls the talkback function through a voice activated relay (VOX) circuit. The paging originator can take control of the talk path at any time by simply speaking. The VOX circuit senses a small voltage and reverts from a listen to a page mode. The talkback control 32 can be turned on or off via a manual DIP switch setting.

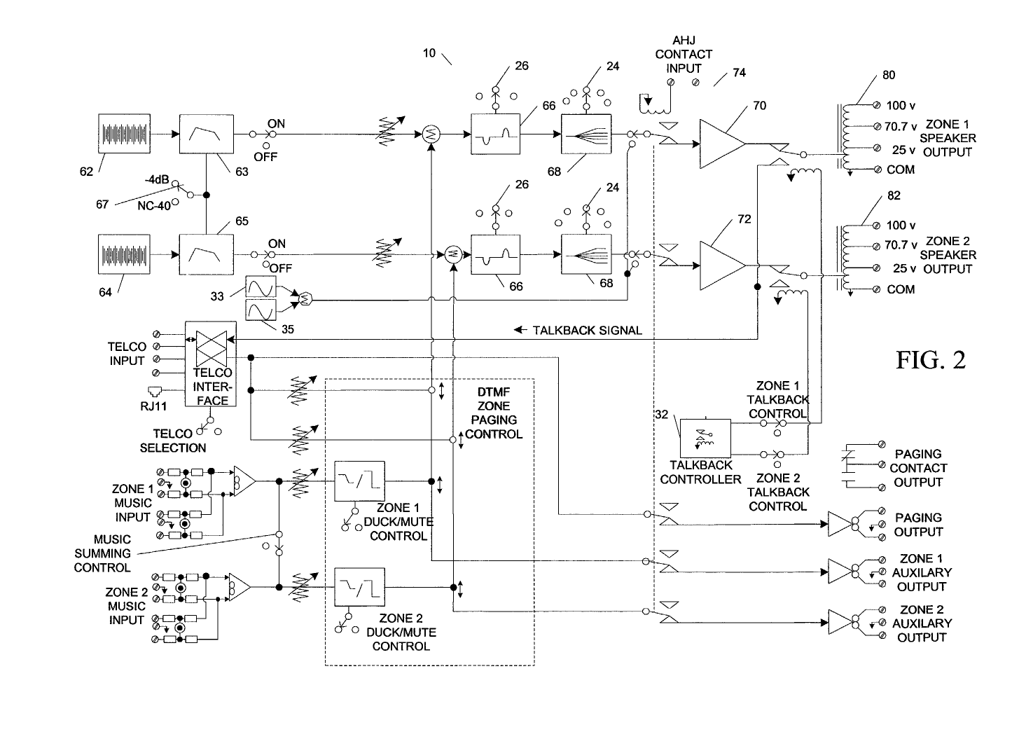

FIG. 2 illustrates a functional block diagram of a two-channel sound processing system 10 of the present invention, corresponding to the circuit block diagram of FIG. 1. The two masking generators 62, 64 are pseudorandom or virtual random noise generators. They provide a flat noise frequency response in the audible range from 20 Hz to 20 KHz. The noise output from each masking generator 62, 64 is filtered by the masking filters 63, 65 to shape the noise within the audible range. More importantly, the masking filters shape the noise within the frequency band of speech, which is from about 200 Hz to 5000 Hz. Two masking curves can be selected using masking filter DIP switch 67. One is the industry standard NC-40 equal loudness curve discussed previously. The other is a −4 dB per octave slope curve in each band of interest. This negatively shaped curve falls off at both low (below 200 Hz) and high (above 5000 Hz) frequencies outside the band of interest. In other embodiments, other sloped masking curves can be provided in the range from about −2 dB per octave to about −6 dB per octave. Likewise, other industry standard equal loudness curves can be used instead of NC-40, or in addition to it.

From experimental testing, the negatively sloped masking curve within the limits specified above, has been found to follow the spectrum of human speech more closely than the industry standard NC-40 equal loudness curve. Consequently, the overall level of masking sound required to produce adequate masking of human speech is reduced and the annoyance associated with the masking sound itself is reduced significantly when compared to an NC-40 masking sound. Although preferable cut-off frequencies and filter curve slopes have been identified above, it is to be understood that these preferred values are not limiting and that values other than the preferred values may well be selected by those of ordinary skill in the art, all within the scope of the present invention. Moreover, the slope of the curve within the frequencies of interest do not need to be constant, but can be varied by those of skill in the art to meet application-specific demands, while remaining within the scope of the invention.

The page and music inputs are not subject to the masking filters, but are subject to speaker and space equalization 66, 68. Thus, music, paging and masking signals are passed through the speaker and acoustic space equalization. The speaker equalization block 66 provides equalization for different speaker configurations. The space equalization block 68 enables selection of different high frequency gains including ±3 dB, ±1.5 dB, or 0 dB (no gain) to compensate for the acoustic environment in which the sound radiators are used. Other gains can be selected within the range of, at least, ±5 dB. The “perceived” outputs from the sound radiators are flat responses.

To generate a test tone to locate the flat panel radiators in an office space, a 300 Hz signal 33 and a 450 Hz signal 35 are added together to generate a test tone that is directed to the stereo Class D amplifier 70. During sound system testing using the generated test tone signal, the test tone signal is routed to the output of the digital signal processor 60 for testing the sound processor connections to the sound radiators. This test tone can be used to determine if the sound radiators are properly wired into the appropriate sound channels, that the transformer output is set to the proper voltage setting, and that the sound radiators are working properly. The unique sound of the test tone makes it easy to localize the flat panel radiators since flat panel radiator sound is indistinguishable from the surrounding sound radiating ceiling panels.

Shown also in FIG. 2 is “authority having jurisdiction” (AHJ) input contact 74. This is a master type input that overrides all music, paging and masking sounds. Authority having jurisdiction can be the local fire department or city building code department. The AHJ function operates once the AHJ contact closure 74 has been closed or sees a low voltage signal from an approved NFPA-UL fire/alarm or voice evacuation system. All the outputs from the DSP 60 are muted when the contact 74 is closed.

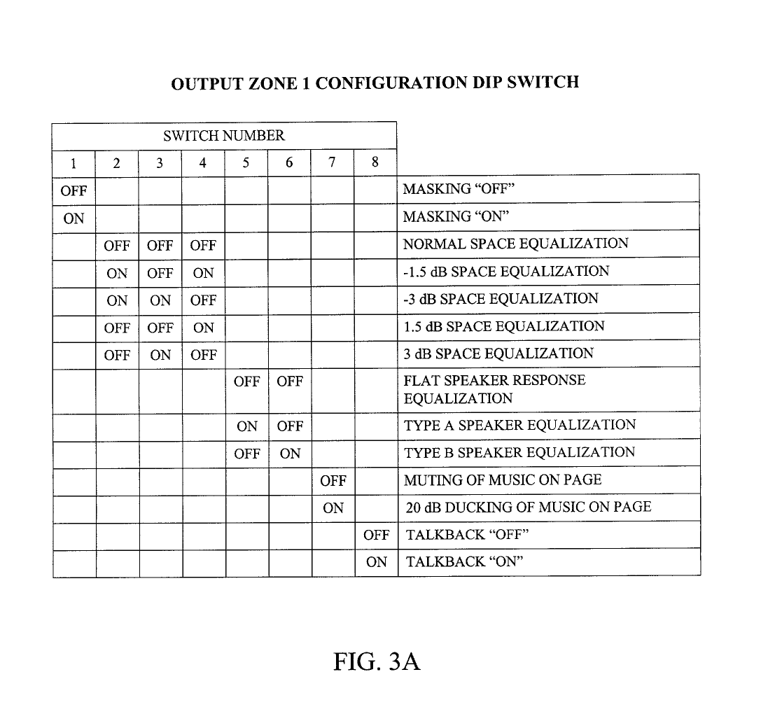

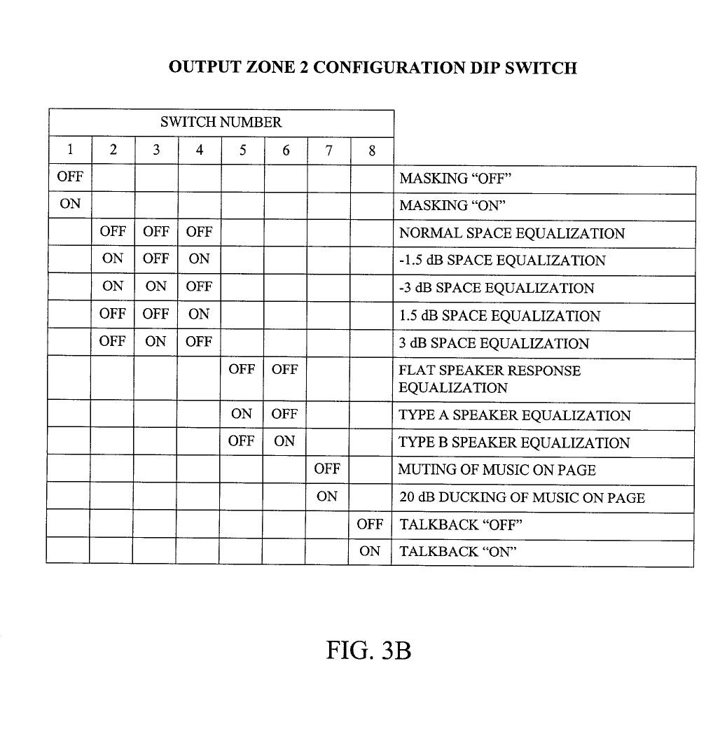

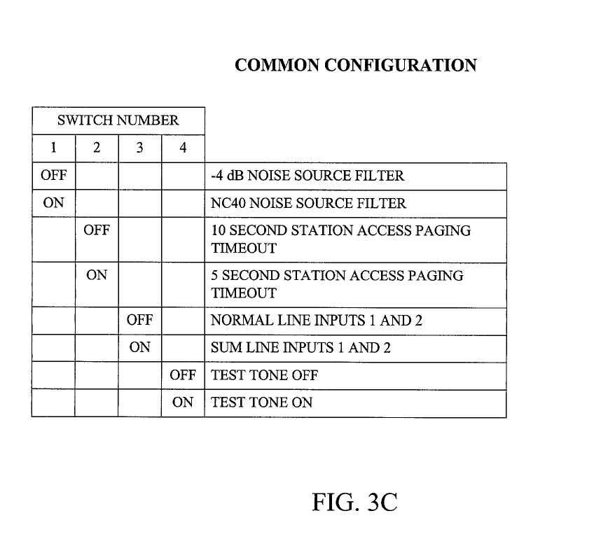

FIGS. 3A-3C illustrate the illustrate DIP switch truth tables for the two channel sound processing system of the present invention. FIGS. 3A and 3B are identical, one being for a first zone and the other for a second zone. Each table shows the DIP switch configuration for masking, space equalization, speaker equalization, muting/ducking and talkback. FIG. 3C shows common configuration DIP switch settings for masking filter, station access paging timeout, input summing and test tone.

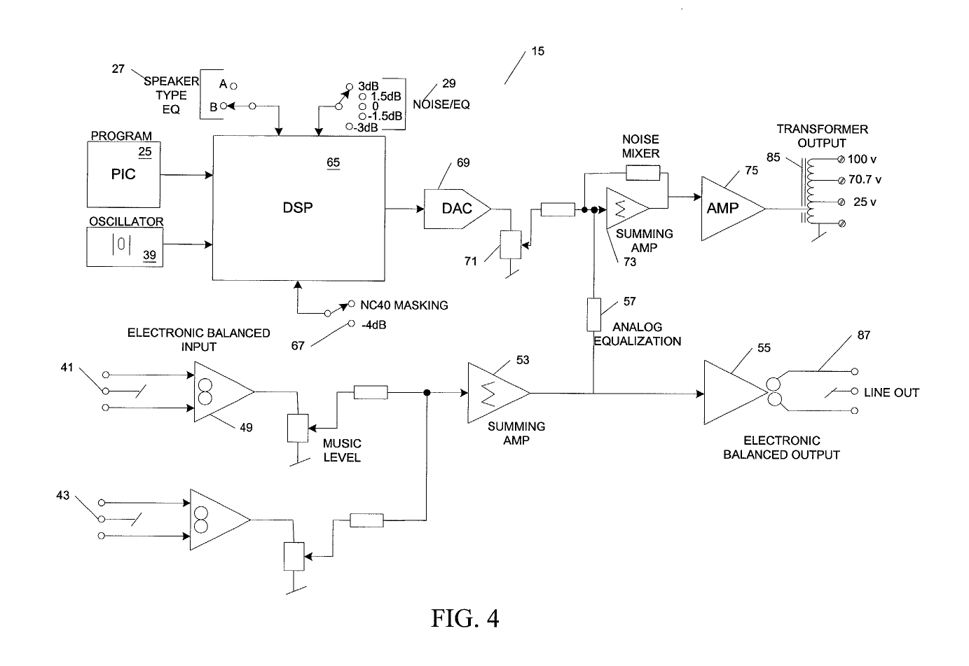

FIG. 4 illustrates a circuit block diagram of a single channel sound processing system 15 of the present invention. This is a simplified version of the two-channel system and is designed to fit within the cover plate of the sound radiator. There is only a single masking source and masking filter located within the DSP 65. The PIC microcontroller 25 controls the operation of the DSP 65. The oscillator 39 as before keeps the DSP 65 running at a fixed sample frequency. This single channel embodiment is intended to operate directly (DIP switch 27) with either type of sound radiator currently available from the assignee of the invention (referred to as type A and type B herein). This single channel embodiment may also be operable with a generic flat panel radiator or more traditional speaker types. The space equalization settings (DIP switch 29): ±3 db, ±1.5 dB, and 0 dB are the same as for the two channel embodiment, although other settings are within the scope of the present invention.

Two masking curves (DIP switch 67) are available with the single channel embodiment. The NC-40 curve and the −4 dB per octave curve are the same as described above, although the invention encompasses the use of other equal loudness or negating sloped curves. The output from the DSP 65 is converted to an analog signal by the digital to analog (D/A) converter 69. Unlike the two-channel sound processing system, in the single channel system 15, only masking noise is generated and passed through the DSP 65. The analog signal is then passed through a noise level control 71 and then summed with the two line inputs in the summing amplifier 73. In order to do paging with the single channel system, a pre-existing public address system with either a paging interface unit or a microphone with a preamplifier can be used with either line input. The two line inputs are summed in summing amplifier 53 and then passed through an analog equalization circuit 57 before being summed with the noise signal in the summing amplifier 73. The output from this summing amplifier 73 is passed to a Class D amplifier 75 and to the transformer 85 to the sound radiators. The output from the first summing amplifier 53 is also sent to another amplifier 55 that is used to drive other single channel sound distribution systems through line output 87.

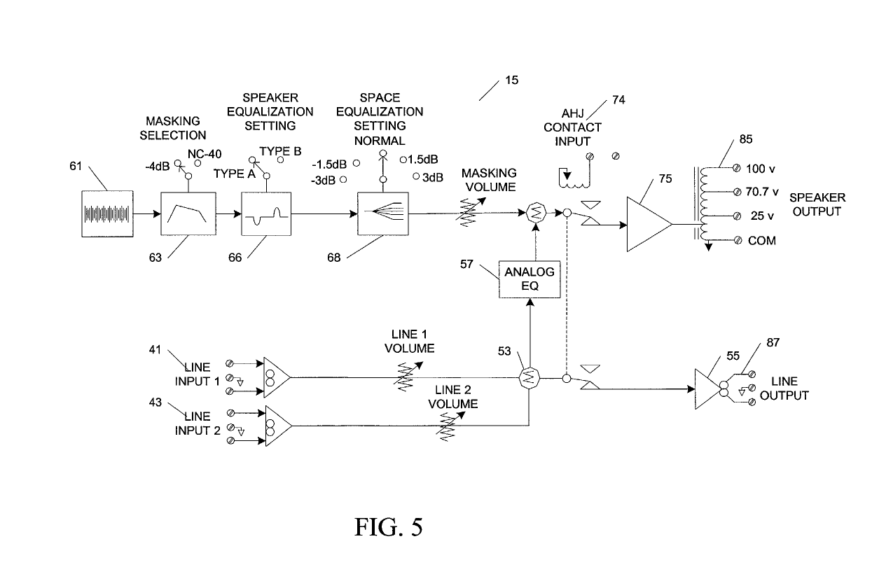

FIG. 5 illustrates a functional block diagram of a single channel sound processing system 15 of the present invention corresponding to the circuit block diagram of FIG. 4. All of the functions depicted on the top part of the functional block diagram are performed in the DSP 65. Thus, the masking generator 61, masking filter 63, speaker equalization 68 and space equalization are all performed in the DSP 65. AHJ functionality 74 is also available with the single channel embodiment to mute all outputs. As described previously, the AHJ function operates once the AHJ contact closure 74 has been closed or sees a low voltage signal from an approved NFPA-UL fire/alarm or voice evacuation system.

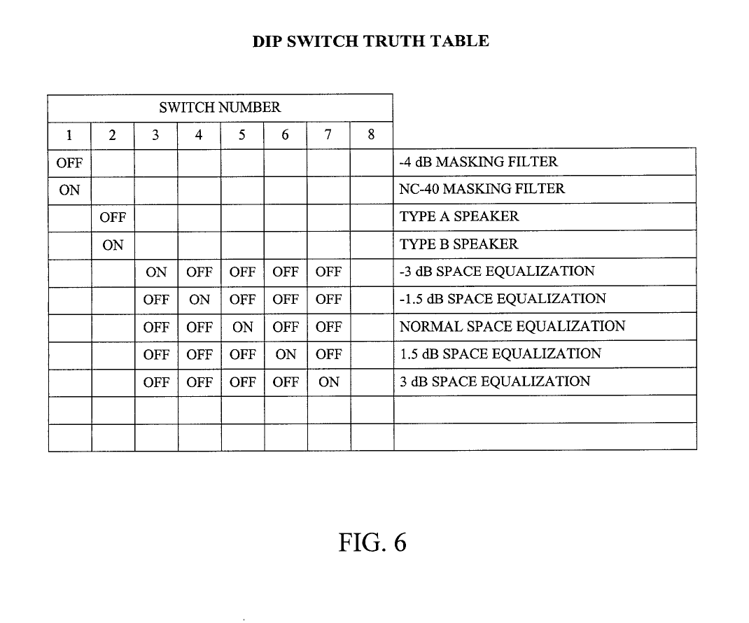

FIG. 6 illustrates a DIP switch truth table for a single channel sound processing system. The table depicts settings for masking filter selection, sound radiator equalization, and space equalization. For example, to ship a single channel system with −4 dB octave masking, type A speaker equalization and no space equalization, DIP switch 1 will be set to “on”, DIP switch 2 will be set to “on”, and DIP switch 5 will be set to “on”. The other DIP switches will be set to “off”.

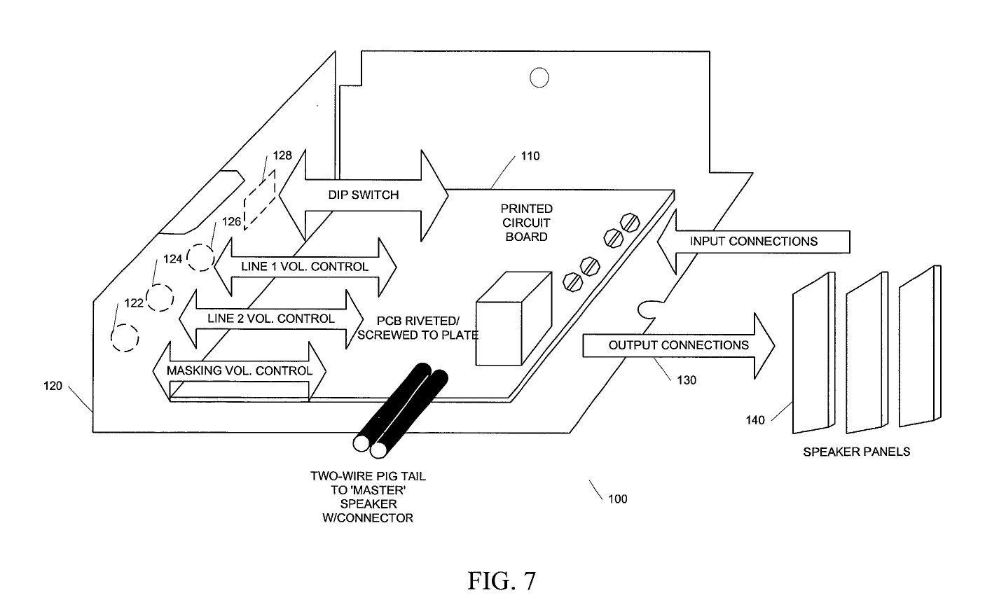

FIG. 7 illustrates the layout for the electronics enclosure 100 mounted to the top of a flat panel sound radiator cover plate. The sound processing system 15 is implemented as a printed circuit board 110 inside the electronics enclosure 100. The side wall 120 of the enclosure has openings 122, 124, 126, 128 to allow access to volume controls for masking, music, and paging, and to DIP switches for equalization control. Output connections 130 from the printed circuit board attach to the sound radiators 140.

The corresponding structures, materials, acts, and equivalents of all means plus function elements in any claims below are intended to include any structure, material or acts for performing the functions in combination with other claim elements as specifically claimed.

Those skilled in the art will appreciate that many modifications to the exemplary embodiment of the present invention are possible without departing from the spirit and scope of the present invention. Some of those possible modifications have been discussed herein. In addition, it is possible to use some of the features of the present invention without the corresponding use of the other features. Accordingly, the foregoing description of the exemplary embodiment is provided for the purpose of illustrating the principles of the present invention and not in imitation thereof since the scope of the present invention is defined solely by the appended claims.

what is claimed is:

1. A sound processing system for use with a plurality of sound radiators comprising:
a telephone interface for accepting a paging signal input;
a microcontroller for accepting a plurality of user-selected sound radiator equalization and space equalization settings and for receiving a paging control signal from the telephone interface;
a digital signal processor for generating and filtering masking noise, and processing the masking noise and the paging signal based on the user-selected settings for distribution to the sound radiators; and
an audio amplifier for modulating and amplifying an output signal from the digital signal processor and delivering the output signal to the sound radiators.

2. The sound processing system for use with a plurality of sound radiators of claim 1 further comprising a plurality of line inputs for accepting music signals for processing by the digital signal processor.

3. The sound processing system for use with a plurality of sound radiators of claim 1 further comprising a transformer for receiving the output signal from the audio amplifier and distributing the output signal at a proper voltage to the sound radiators.

4. The sound processing system for use with a plurality of sound radiators of claim 3 wherein the proper voltage is selected from the group consisting of 25 volts, 70.7 volts, and 100 volts.

5. The sound processing system for use with a plurality of sound radiators of claim 2 further comprising an analog mixer for combining the music signals, and an analog-to-digital converter for converting the combined signal to a digital signal and inputting the digital signal to the digital signal processor.

6. The sound processing system for use with a plurality of sound radiators of claim 5 wherein the analog mixer further combines the paging signal with the music signals before converting the combined signal to a digital signal.

7. The sound processing system for use with a plurality of sound radiators of claim 2 wherein the plurality of input lines are associated with at least two music input circuits for distribution to the plurality of sound radiators in at least two defined zones.

8. The sound processing system for use with a plurality of sound radiators of claim 1 wherein the sound radiator equalization setting enables user selection of a specific type of sound radiator.

9. The sound processing system for use with a plurality of sound radiators of claim 8 wherein at least two different types of sound radiators can be user selected.

10. The sound processing system for use with a plurality of sound radiators of claim 8 wherein the specific type of sound radiator is characterized by a uniform frequency response over an audible range of frequencies.

11. The sound processing system for use with a plurality of sound radiators of claim 8 wherein the specific type of sound radiator is a flat panel sound radiator.

12. The sound processing system for use with a plurality of sound radiators of claim 8 wherein the specific type of sound radiator uses conventional speaker technology.

13. The sound processing system for use with a plurality of sound radiators of claim 8 wherein a sound radiator equalization processing in the digital signal processor compensates for the frequency response characteristics of the selected radiator type.

14. The sound processing system for use with a plurality of sound radiators of claim 10 wherein the audible range of frequencies is from 20 Hz to 20,000 Hz.

15. The sound processing system for use with a plurality of sound radiators of claim 1 wherein the space equalization settings enable user selection of one of a plurality of gain values to compensate during a space equalization processing in the digital signal processor for the acoustic characteristics of an enclosed space in which the sound radiators are used.

16. The sound processing system for use with a plurality of sound radiators of claim 15 wherein the plurality of gain values are in the range from about −5 dB to about +5 dB.

17. The sound processing system for use with a plurality of sound radiators of claim 1 wherein the plurality of user selectable sound radiator and space equalization settings are controlled by switch settings.

18. The sound processing system for use with a plurality of sound radiators of claim 1 wherein the digital signal processor includes a plurality of masking generators that generate random noise for sound masking.

19. The sound processing system for use with a plurality of sound radiators of claim 18 wherein the digital signal processor includes a masking filter for each masking generator.

20. The sound processing system for use with a plurality of sound radiators of claim 19 wherein the masking filter is programmed to shape the generated random noise by decreasing the noise at a constant rate over at least a portion of a range of frequencies from about 20 Hz to about 20,000 Hz.

21. The sound processing system for use with a plurality of sound radiators of claim 20 wherein the masking filter shapes the generated random noise over a range of frequencies from about 200 Hz to about 5000 Hz.

22. The sound processing system for use with a plurality of sound radiators of claim 21 wherein the constant rate is in the range from about −2 dB to about −6 dB per octave.

23. The sound processing system for use with a plurality of sound radiators of claim 21 wherein the constant rate is about −4 dB per octave.

24. The sound processing system for use with a plurality of sound radiators of claim 19 wherein the masking filter is programmed to shape the generated noise by applying a noise criteria equal loudness curve to the noise.

25. The sound processing system for use with a plurality of sound radiators of claim 24 wherein the noise criteria equal loudness curve is about NC-40.

26. The sound processing system for use with a plurality of sound radiators of claim 19 wherein the masking filter is selectable by the user.

27. The sound processing system for use with a plurality of sound radiators of claim 1 further comprising a user-selectable switch to enable either one of a muting function or a paging-over-music function for the output of the digital signal processor when the paging control signal is received from the telephone interface.

28. The sound processing system for use with a plurality of sound radiators of claim 27 wherein the user-selectable paging-over-music function reduces a level of the music by a preset amount when the paging control signal is received.

29. The sound processing system for use with a plurality of sound radiators of claim 28 wherein the preset amount is about −20 dB.

30. The sound processing system for use with a plurality of sound radiators of claim 1 further comprising a voices-activated relay circuit to enable a person to respond to a page using a sound radiator as a microphone.

31. The sound processing system for use with a plurality of sound radiators of claim 1 further comprising a master input contact closure for overriding all paging, masking noise and music sounds.

32. The sound processing system for use with a plurality of sound radiators of claim 1 wherein the digital sound processor is installed in a wiring closet.

33. A sound processing system for use with a plurality of sound radiators comprising:
a microcontroller for accepting a plurality of user-selected sound radiator equalization and space equalization settings;
a digital signal processor for generating and filtering masking noise, and processing the masking noise based on the user-selected settings for distribution to the sound radiators; and
an audio amplifier for modulating and amplifying an output signal from the digital signal processor and delivering the output signal to the sound radiators.

34. The sound processing system for use with a plurality of sound radiators of claim 33 further comprising a plurality of line inputs for accepting music signals that are summed and mixed with the noise output from the digital signal processor.

35. The sound processing system for use with a plurality of sound radiators of claim 34 further comprising an analog equalization circuit for shaping the summed music signals before combining the summed music signals with the noise output of the digital signal processor.

36. The sound processing system for use with a plurality of sound radiators of claim 34 further comprising a summing amplifier for adding the noise output of the digital signal processor with the output of the analog equalization circuit.

37. The sound processing system for use with a plurality of sound radiators of claim 33 further comprising a transformer for receiving the output signal from the audio amplifier and distributing the output signal at a proper voltage to the sound radiators.

38. The sound processing system for use with a plurality of sound radiators of claim 37 wherein the proper voltage is selected from the group consisting of 25 volts, 70.7 volts, and 100 volts.

39. The sound processing system for use with a plurality of sound radiators of claim 33 wherein the sound radiator equalization setting enables user selection of a specific type of sound radiator.

40. The sound processing system for use with a plurality of sound radiators of claim 39 wherein at least two different types of sound radiators can be user selected.

41. The sound processing system for use with a plurality of sound radiators of claim 39 wherein the specific type of sound radiator is characterized by a uniform frequency response over an audible range of frequencies.

42. The sound processing system for use with a plurality of sound radiators of claim 39 wherein the specific type of sound radiator is a flat panel sound radiator.

43. The sound processing system for use with a plurality of sound radiators of claim 39 wherein the specific type of sound radiator uses conventional speaker technology.

44. The sound processing system for use with a plurality of sound radiators of claim 39 wherein a sound radiator equalization processing in the digital signal processor compensates for the frequency response characteristics of the selected radiator type.

45. The sound processing system for use with a plurality of sound radiators of claim 41 wherein the audible range of frequencies is from 20 Hz to 20,000 Hz.

46. The sound processing system for use with a plurality of sound radiators of claim 33 wherein the space equalization settings enable user selection of one of a plurality of gain values to compensate during a space equalization processing in the digital signal processor for the acoustic characteristics of an enclosed space in which the sound radiators are used.

47. The sound processing system for use with a plurality of sound radiators of claim 46 wherein the plurality of gain values are in the range from about −5 dB to about +5 dB.

48. The sound processing system for use with a plurality of sound radiators of claim 33 wherein the plurality of user selectable sound radiator and space equalization settings are controlled by switch settings.

49. The sound processing system for use with a plurality of sound radiators of claim 33 wherein the digital signal processor includes a masking generator that generates random noise for sound masking.

50. The sound processing system for use with a plurality of sound radiators of claim 49 wherein the digital signal processor includes a masking filter for the masking generator.

51. The sound processing system for use with a plurality of sound radiators of claim 50 wherein the masking filter is programmed to shape the generated random noise by decreasing the noise at a constant rate over at least a portion of a range of frequencies from about 20 Hz to about 20,000 Hz.

52. The sound processing system for use with a plurality of sound radiators of claim 51 wherein the masking filter shapes the generated random noise over a range of frequencies from about 200 Hz to about 5000 Hz.

53. The sound processing system for use with a plurality of sound radiators of claim 52 wherein the constant rate is in the range from about −2 dB to about −6 dB per octave.

54. The sound processing system for use with a plurality of sound radiators of claim 52 wherein the constant rate is about −4 dB per octave.

55. The sound processing system for use with a plurality of sound radiators of claim 50 wherein the masking filter is programmed to shape the generated noise by applying a noise criteria equal loudness curve to the noise.

56. The sound processing system for use with a plurality of sound radiators of claim 55 wherein the noise criteria equal loudness curve is about NC-40.

57. The sound processing system for use with a plurality of sound radiators of claim 50 wherein the masking filter is selectable by the user.

58. The sound processing system for use with a plurality of sound radiators of claim 33 further comprising a master input contact closure for overriding all masking noise and music sounds.

59. The sound processing system for use with a plurality of sound radiators of claim 33 wherein the digital sound processor is installed in an enclosure mounted on a bridge support attached to the sound radiators.

60. A method for combining masking sound, paging and music signals in a sound processing system and delivering the combined signals to a plurality of sound radiators, the method comprising the steps of:
accepting a paging signal input from a telephone interface;
accepting a plurality of user-selected sound radiator equalization and space equalization settings at a microcontroller;
receiving a paging control signal from the telephone interface;
generating and filtering masking noise, and processing the masking noise and the paging signal in a digital signal processor based on the user-selected settings for distribution to the sound radiators; and
modulating and amplifying an output signal from the digital signal processor in an audio amplifier, and delivering the output signal to the sound radiators.

61. The method for combining masking sound, paging and music signals in a sound processing system of claim 60 further comprising the step of accepting music signals from a plurality of line inputs for processing by the digital signal processor.

62. The method for combining masking sound, paging and music signals in a sound processing system of claim 60 further comprising the step of receiving the output signal from the audio amplifier at a transformer and distributing the output signal at a proper voltage to the sound radiators.

63. The method for combining masking sound, paging and music signals in a sound processing system of claim 60 wherein the proper voltage is selected from the group consisting of 25 volts, 70.7 volts, and 100 volts.

64. The method for combining masking sound, paging and music signals in a sound processing system of claim 60 further comprising the steps of combining the music signals in an analog mixer, converting the combined signal to a digital signal, and inputting the digital signal to the digital signal processor.

65. The method for combining masking sound, paging and music signals in a sound processing system of claim 64 further comprises the step of combining the paging signal with the music signals before converting the combined signal to a digital signal.

66. The method for combining masking sound, paging and music signals in a sound processing system of claim 61 wherein the plurality of input lines are associated with at least two music input circuits for distribution to the plurality of sound radiators in at least two defined zones.

67. The method for combining masking sound, paging and music signals in a sound processing system of claim 60 wherein the sound radiator equalization setting enables user selection of a specific type of sound radiator.

68. The method for combining masking sound, paging and music signals in a sound processing system of claim 67 wherein at least two different types of sound radiators can be user selected.

69. The method for combining masking sound, paging and music signals in a sound processing system of claim 67 wherein the specific type of sound radiator is characterized by a uniform frequency response over an audible range of frequencies.

70. The method for combining masking sound, paging and music signals in a sound processing system of claim 67 wherein the specific type of sound radiator is a flat panel sound radiator.

71. The method for combining masking sound, paging and music signals in a sound processing system of claim 67 wherein the specific type of sound radiator uses conventional speaker technology.

72. The method for combining masking sound, paging and music signals in a sound processing system of claim 67 further comprising the step of performing sound radiator equalization processing in the digital signal processor to compensate for the frequency response characteristics of the selected radiator type.

73. The method for combining masking sound, paging and music signals in a sound processing system of claim 69 wherein the audible range of frequencies is from 20 Hz to 20,000 Hz.

74. The method for combining masking sound, paging and music signals in a sound processing system of claim 60 further comprising the step of selecting one of a plurality of gain values to compensate during a space equalization processing in the digital signal processor for the acoustic characteristics of an enclosed space in which the sound radiators are used.

75. The method for combining masking sound, paging and music signals in a sound processing system of claim 74 wherein the plurality of attenuation values are in the range from about −5 dB to about +5 dB.

76. The method for combining masking sound, paging and music signals in a sound processing system of claim 60 further comprising the step of programming a masking filter in a masking noise generator to shape the generated random noise by decreasing the noise at a constant rate over at least a portion of a range of frequencies for about 20 Hz to about 20,000 Hz.

77. The method for combining masking sound, paging and music signals in a sound processing system of claim 76 wherein the masking filter shapes the generated random noise over a range of frequencies from about 200 Hz to about 5000 Hz.

78. The method for combining masking sound, paging and music signals in a sound processing system of claim 77 wherein the constant rate is in the range from about −2 dB to about −6 dB per octave.

79. The method for combining masking sound, paging and music signals in a sound processing system of claim 77 wherein the constant rate is about −4 dB per octave.

80. The method for combining masking sound, paging and music signals in a sound processing system of claim 76 wherein the step of programming the masking filter comprises applying a noise criteria equal loudness curve to the noise.

81. The method for combining masking sound, paging and music signals in a sound processing system of claim 80 wherein the noise criteria equal loudness curve is about NC-40.

82. The method for combining masking sound, paging and music signals in a sound processing system of claim 60 further comprising the step of selecting either one of a muting function or a paging-over-music function for the output of the digital signal processor when the paging control signal is received from the telephone interface.

83. The method for combining masking sound, paging and music signals in a sound processing system of claim 82 wherein selecting the paging-over-music function reduces a level of the music by a preset amount when the paging control signal is received.

84. The method for combining masking sound, paging and music signals in a sound processing system of claim 83 wherein the preset amount is about −20 dB.

85. The method for combining masking sound, paging and music signals in a sound processing system of claim 60 further comprising the step of enabling a person to respond to a page using a sound radiator as a microphone through a voice activated relay circuit.

86. The method for combining masking sound, paging and music signals in a sound processing system of claim 60 further comprising the step of closing a master input contact closure to mute all paging, masking noise and music sounds.

87. A method for combining masking sound, paging and music signals in a sound processing system and delivering the combined signals to a plurality of sound radiators, the method comprising the steps of:
accepting a plurality of user-selected sound radiator equalization and space equalization settings at a microcontroller;
generating and filtering masking noise, and processing the masking noise in a digital signal processor based on the user-selected settings for distribution to the sound radiators; and
modulating and amplifying an output signal from the digital signal processor in an audio amplifier, and delivering the output signal to the sound radiators.

88. The method for combining masking sound, paging and music signals in a sound processing system of claim 87 further comprising the steps of accepting music signals from a plurality of line inputs, and summing and mixing the music signals with the noise output from the digital signal processor.

89. The method for combining masking sound, paging and music signals in a sound processing system of claim 88 further comprising the step of shaping the summed music signals using an analog equalization circuit before combining the summed music signals with the noise output of the digital signal processor.

90. The method for combining masking sound, paging and music signals in a sound processing system of claim 88 further comprising the step of adding the noise output of the digital signal processor with the output of the analog equalization circuit in a summing amplifier.

91. The method for combining masking sound, paging and music signals in a sound processing system of claim 87 further comprising the step of receiving the output signal from the audio amplifier at a transformer and distributing the output signal at a proper voltage to the sound radiators.

92. The method for combining masking sound, paging and music signals in a sound processing system of claim 91 wherein the proper voltage is selected from the group consisting of 25 volts, 70.7 volts, and 100 volts.

93. The method for combining masking sound, paging and music signals in a sound processing system of claim 87 wherein the sound radiator equalization setting enables user selection of a specific type of sound radiator.

94. The method for combining masking sound, paging and music signals in a sound processing system of claim 93 wherein at least two different types of sound radiators can be user selected.

95. The method for combining masking sound, paging and music signals in a sound processing system of claim 93 wherein the specific type of sound radiator is characterized by a uniform frequency response over an audible range of frequencies.

96. The method for combining masking sound, paging and music signals in a sound processing system of claim 93 wherein the specific type of sound radiator is a flat pane l sound radiator.

97. The method for combining masking sound, paging and music signals in a sound processing system of claim 93 wherein the specific type of sound radiator uses conventional speaker technology.

98. The sound processing system for use with a plurality of sound radiators of claim 93 further comprising the step of performing sound radiator equalization processing in the digital signal processor to compensate for the frequency response characteristics of the selected radiator type.

99. The method for combining masking sound, paging and music signals in a sound processing system of claim 95 wherein the audible range of frequencies is from 20 Hz to 20,000 Hz.

100. The method for combining masking sound, paging and music signals in a sound processing system of claim 87 further comprising the step of selecting one of a plurality of gain values to compensate during a space equalization processing in the digital signal processor for the acoustic characteristics of an enclosed space in which the sound radiators are used.

101. The method for combining masking sound, paging and music signals in a sound processing system of claim 99 wherein the plurality of gain values are in the range from about −5 dB to about +5 dB.

102. The method for combining masking sound, paging and music signals in a sound processing system of claim 87 further comprising the step of programming a masking filter in a masking noise generator to shape the generated random noise by decreasing the noise at a constant rate over at least a portion of a range of frequencies from about 20 Hz to about 20,000 Hz.

103. The method for combining masking sound, paging and music signals in a sound processing system of claim 102 wherein the masking filter shapes the generated random noise over a range of frequencies from about 200 Hz to about 5000 Hz.

104. The method for combining masking sound, paging and music signals in a sound processing system of claim 103 wherein the constant rate is in the range from about −2 dB to about −6 dB per octave.

105. The method for combining masking sound, paging and music signals in a sound processing system of claim 103 wherein the constant rate is about −4 dB per octave.

106. The method for combining masking sound, paging and music signals in a sound processing system of claim 102 wherein the step of programming the masking filter comprises applying a noise criteria equal loudness curve to the noise.

107. The method for combining masking sound, paging and music signals in a sound processing system of claim 106 wherein the noise criteria equal loudness curve is about NC-40.

108. The method for combining masking sound, paging and music signals in a sound processing system of claim 87 further comprising the step of closing a master input contact closure to mute all masking noise and music sounds.
